(19) United States
(12) Patent Application Publication
(10) Pub. No.: US 2010/0324959 A1
(43) Pub. Date: Dec. 23, 2010

(54) Processing Shipment Status Events

(76) Inventors: William P. Templeton, Seattle, WA (US); M. Christopher Wenneman, Seattle, WA (US); Benjamin Elliott Pew, Seattle, WA (US); Jacob Frank Lucas, Seattle, WA (US); Michael E. Bundy, Seattle, WA (US); Michael Thomas Seifert, Mercer Island, WA (US); Jacob A. Kjelstrup, Sammamish, WA (US)

Correspondence Address: Client 170101 c/o;THOMAS , KAYDEN , HORSTEMEYER& RISLEY , LLP, 600 GALLERIA PARKWAY, Suite 1500, ATLANTA, GA, 30339-5948, US

(21) Appl. No.: 12/486,902

(22) Filed: Jun. 18, 2009

(51) Int. Cl. G06Q 10/00; G06Q 30/00

(52) U.S. Cl. 705/8; 705/28; 705/14.1

(57) ABSTRACT

Disclosed are various embodiments for processing shipment status events. An instance of a first event is obtained from a carrier. The instance of the first event is associated with a shipment in transit with the carrier, and the first event is associated with a set of first events used by the carrier to describe shipment status. The instance of the first event is mapped to an instance of a second event. The second event is associated with a set of second events, each describing a shipment status and being normalized with respect to sets of first events associated with multiple carriers. At least one action based at least in part on the instance of the second event is implemented.

### BACKGROUND

Shipping carriers may have systems in place to track the status of packages being shipped by the carrier. For example, a barcode may be placed on a package and then that barcode may be scanned when the package is loaded onto or offloaded from a delivery truck. Shipments may be tracked through the use of a unique tracking number in conjunction with a web portal operated by a shipping carrier.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of a networked environment according to various embodiments of the present disclosure.

FIG. 2 is a flowchart that provides one example of functionality for a shipment event processing application employed in the networked environment of FIG. 1 according to an embodiment of the present disclosure.

FIG. 3 is a schematic block diagram that illustrates one example of a server employed in the networked environment of FIG. 1 according to an embodiment of the present disclosure.

### DETAILED DESCRIPTION

Many shipping carriers track the progress of shipments that are currently in transit. For example, a package in a shipment may have one or more barcodes, radio frequency identifiers (RFIDs), and/or other identifiers, thereby allowing the shipment to be recognized upon an input of one of the identifiers into a tracking system of the carrier. The context and other data associated with the input identifier may enable the tracking system to determine a status of the shipment. As a non-limiting example, the system learns that packages are currently at a given location when the respective identifiers are recognized while the packages are being off-loaded at a given location. In this way, a location status event for each shipment may be generated. As another non-limiting example, a package may be damaged in transit, and an employee may input the identifier associated with the package along with an additional status identifier describing the package as damaged. In this way, a damaged status event for the shipment may be generated.

Carriers may make status events regarding a shipment available to external users, such as the sender, recipient, or some other party. However, different carriers may have different interfaces for obtaining the status events. Further, different carriers may track different types of status events. Carrier A may track 10,000 different types of status events, while Carrier B may track only forty different types of status events. Some status events of some carriers may be inconsequential and insignificant to a sender or recipient. A sequence of status events from a carrier may correspond to a single logical status event. Also, several status events from a first carrier may correspond to a single event from a second carrier.

Described herein is a system for processing shipment status events that can obtain status events from multiple carriers and map them to normalized status events that may be used to describe status events from more than one carrier. The system may then implement one or more actions based on a normalized status event associated with a shipment. Such actions may include, but are not limited to, generating a map that displays a current location of the shipment, sending a notification, etc. Such a notification may comprise, for example, an email, a text message, a phone call, a network page, and other types of notifications.

If the system is operated, for example, by a retailer or other entity that has access to data including, for example, the contents of the shipment, payment instruments used to pay for the shipment, customer information, etc., then the system may also implement one or more actions based on such data. Such actions may include, but are not limited to, automatically providing a refund to the customer who ordered the shipment, obtaining additional data from the customer, reshipping the order associated with the shipment, etc. In the following discussion, a general description of the system and its components is provided, followed by a discussion of the operation of the same.

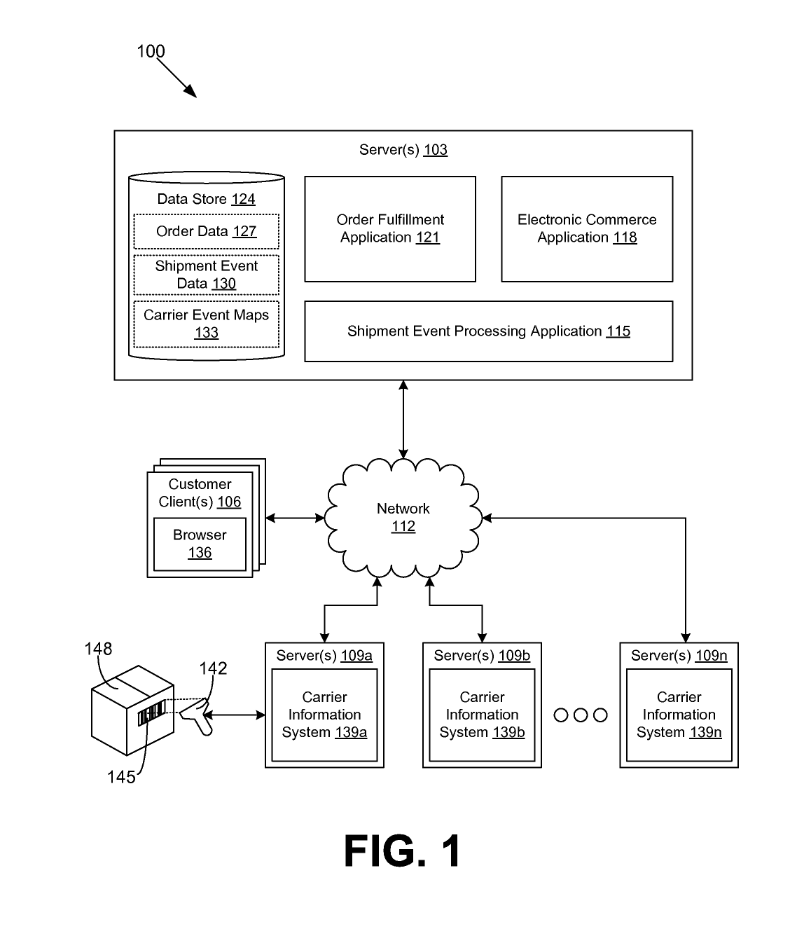

With reference to FIG. 1, shown is a networked environment 100 according to various embodiments of the present disclosure. The networked environment 100 includes a server 103 that is in data communication with customer clients 106 and one or more servers 109a-109n by way of a network 112. Although three servers 109 are shown in FIG. 1 as an example, it is understood that there may be any number of servers 109. The network 112 includes, for example, the Internet, intranets, extranets, wide area networks (WANs), local area networks (LANs), wired networks, wireless networks, or other suitable networks, etc., or any combination of two or more such networks.

The server 103 may comprise, for example, a server computer or like system. The server 103 may represent multiple servers arranged, for example, in one or more server banks or other arrangements. Such servers 103 may be located in a single installation or may be dispersed among many different geographical locations. For purposes of convenience, the server 103 is referred to herein in the singular. However, in one embodiment, the server 103 represents a plurality of servers arranged as described above.

The server 103 is configured to execute various applications such as, for example, a shipment event processing application 115, an electronic commerce application 118, an order fulfillment application 121, and other applications. The shipment event processing application 115 is executed to process shipment status events provided by carriers to map the carrier-provided status events to normalized status events that may be common to more than one carrier. The shipment event processing application 115 also implements actions in response to the normalized status events and performs other functions as will be described. The electronic commerce application 118 is executed to perform functions relating to interfacing with customers to receive item orders, payment information, contact information, and other customer information relating to orders. The order fulfillment application 121 is executed to perform functions relating to fulfillment of orders, such as, for example, generating a shipping manifest at a fulfillment center, receiving data relating to returned items, and other functions.

The server 103 includes a data store 124 and potentially other data stores, which may comprise data and applications configured to provide access to the data. The data store 124 may be used to store order data 127, shipment event data 130, carrier event maps 133, and/or potentially other data. Order data 127 may comprise data relating to items ordered, which may include item weights, prices, quantities, etc.; shipping information, which may include carrier information, tracking numbers, package weights, shipping costs, shipping class (e.g., ground, first-class, priority, etc.); and/or customer information, which may include payment information, contact information, shipping address, gift information, etc., and/or other data. Shipment event data 130 may comprise data relating to shipment status events that have been obtained for orders and potentially other data. Carrier event maps 133 may comprise data used to map one or more carrier-provided status events with one or more normalized status events and potentially other data.

Each of the customer clients 106 may comprise, for example, a computer system such as a desktop, laptop, or other computer system. The customer clients 106 may also comprise personal digital assistants, cellular telephones, set-top boxes, or other systems with like capability. Further, the customer clients 106 may also comprise any device that is network capable that may communicate with the server 103 over the network 112 to perform various functions. Such customer clients 106 may comprise, for example, processor-based devices having processor circuits comprising a processor and a memory.

The customer clients 106 may be configured to execute various applications such as a browser 136 and/or other applications. The browser 136 may be executed in a customer client 106, for example, to access and render network pages, such as web pages, or other network content served up by the server 103 and/or other servers. The customer clients 106 may be configured to execute applications beyond browser 136 such as, for example, email applications, instant message applications, and other applications.

Each server 109 may comprise, for example, a server computer or like system. Each server 109 may represent multiple servers arranged, for example, in one or more server banks or other arrangements. Such a server 109 may be located in a single installation or may be dispersed among many different geographical locations. For purposes of convenience, each server 109 is referred to herein in the singular. However, in one embodiment, one or more servers 109 represents a plurality of servers arranged as described above. In another embodiment, there may be only one server 109.

Each server 109 is associated with a respective shipping carrier, such as a common carrier, which ships and delivers packages to a destination. Examples of such carriers include, but are not limited to, the UNITED STATES POSTAL SERVICE®, FEDEX®, UPS®, DHL®, and other carriers. The server 109 may be, in some cases, located on the premise of the carrier. Each server 109 is configured to execute various applications such as, for example, a carrier information system 139 and other applications. The carrier information system 139 provides shipment status events for shipments 148 in transit with the respective carrier.

Each server 109 is in data communication with any number of computer systems associated with the respective carrier. As a non-limiting example, server 109a may be in data communication with a scanner 142. Scanner 142 may be, for example, a handheld scanner used to input one or more identifiers 145 associated with a shipment 148. As shown in the non-limiting illustration of FIG. 1, shipment 148 is a box having an identifier 145 comprising a bar code or other type of identifier. Shipment 148 may comprise any type of package that is being shipped. There may be multiple identifiers 145 attached to the shipment 148 or otherwise associated with the shipment 148 (for example, on an outer container known to contain shipment 148 and other shipments). The identifier 145 may comprise, in other embodiments, numbers, RFID tags, images, and/or other types of identifiers.

Next, a general description of the operation of the various components of the networked environment 100 is provided. To begin, a customer places an order with the electronic commerce application 118 using customer client 106 and browser 136. The customer may select one or more items to purchase, for example, through a network page. During the order process, the customer may provide various information to the electronic commerce application 118. This information may include, for example, phone numbers, fax numbers, email addresses, payment information (such as credit card, electronic check, etc.), billing address, shipping addresses, preferred shipping carrier, preferred shipping method or class, and/or other information. Some information may already be stored within data store 124 and associated with an account of the customer.

Upon placing the order, the electronic commerce application 118 may store data related to the order, including the collected information, in order data 127. The electronic commerce application 118 may instruct the order fulfillment application 121 to begin processing the order, which may produce multiple shipments 148. A carrier is selected for each shipment 148 in the order. In some embodiments, the customer may specify or select the carrier. In other embodiments, the sender may select the carrier. The carrier selection may be based, for example, lowest cost, reliability, sender preference, and/or other factors. The order fulfillment application 121 may then generate one or more shipping manifests at one or more fulfillment centers to fulfill the order.

Through various fulfillment processes, the ordered items are picked from storage locations at the fulfillment center and prepared for shipping as shipments 148. As a non-limiting example, the ordered items may be packed within a box, and a shipping label generated by the order fulfillment application 121 may be attached to the box. The type of shipping label and the type of packaging may depend on the particular carrier that is associated with the order. One or more unique tracking numbers may be generated for the order by the order fulfillment application 121 and stored within order data 127. The shipping label may include an identifier 145, which may be associated with a unique tracking number. In other embodiments, the shipping label may include multiple identifiers 145, which may be associated with multiple unique tracking numbers. In some embodiments, an identifier 145 may include a shipment identifier that is encrypted, which in turn may be correlated with a unique tracking number.

After the shipments 148 are prepared, each of the shipments 148 is placed into transit with the respective carrier. Data respecting the shipment 148 may be sent from the order fulfillment application 121 to the respective carrier information system 139. Such data may include a shipping address, weight and/or other physical characteristics of the shipment 148, shipping method and options, and other data.

However, in various embodiments, the carrier information system 139 may have incomplete information about the shipment 148. For example, in the case that the customer and recipient are different (such as, for example, when the order is a gift from the customer to the recipient), even if the carrier information system 139 has contact information about the shipment 148, it may have contact information only for the recipient, and not for the customer who placed the order. Also, even if the shipment 148 has a declared value for customs purposes, the carrier information system 139 may not have all of the payment information for the customer. Moreover, the carrier information system 139 may not know precisely what items are contained within the shipment 148. In summary, the carrier information system 139 may have only an incomplete view of the data stored within order data 127.

When the carrier is informed of the shipment 148, or when the shipment 148 is placed in transit with the carrier, the carrier information system 139 is adapted to provide instances of events regarding the status of the shipment 148 to the shipment event processing application 115 over the network 112. In one embodiment, the shipment event processing application 115 registers with the respective carrier information system 139 to receive the events associated with the shipment 148 when the carrier information system 139 generates the events. In another embodiment, the shipment event processing application 115 polls the carrier information system 139 for new events associated with the shipment 148.

In some embodiments, a shipment 148 may be in transit through multiple carriers. Thus, the shipment event processing application 115 may be in communication with a plurality of carrier information systems 139 regarding a particular shipment 148. In other cases, a shipment event processing application 115 may receive information from one carrier information system 139 regarding the multiple carriers.

As a non-limiting example, the carrier may scan an identifier 145 on a shipment 148 using a scanner 142. The carrier information system 139 may learn from the data already available to the carrier information system 139 that the shipment 148 is currently being loaded onto a truck or other transport apparatus at a certain location (such as at the fulfillment center, for example), processed within a shipping hub, processed at customs, delivered at the premise of the customer, etc. The carrier information system 139 may receive additional input and/or generate additional data about the shipment 148 regarding, for example, damage, delay, refused and/or attempted delivery, confiscation, etc.

In response to a scanned identifier 145 and/or other data, the carrier information system 139 may be configured to generate an instance of an event regarding the status of the shipment 148. The event may be associated with a particular scan of an identifier 145 or may be unrelated to a scan of an identifier 145. In one embodiment, the carrier information system 139 may regularly generate status events about the shipment 148 before, during, and/or after the transit of the shipment 148.

The instance of a status event generated by the carrier information system 139 may, in some cases, employ a character string, numerical identifier, or some other type of identifier 145 that is defined by and associated with a particular status event by the respective carrier. It is understood that different carriers may use the same or different identifiers 145 to describe status events. It is further understood that different carriers may be associated with different sets of status events. Where a shipment 148 is in transit with multiple carriers, a carrier information system 139 may provide shipment events from one or more of the carriers and may use the identifiers 145 of one or more of the carriers.

Thus, the shipment event processing application 115 obtains one or more instances of status events regarding a shipment 148 from a carrier information system 139 of a carrier. The event instances may be transferred over a network 112 from the carrier information system 139 to the shipment event processing application 115 using, as non-limiting examples, an electronic data interchange (EDI) message and/or an extensible markup language (XML) message sent over hypertext transfer protocol (HTTP), simple object access protocol (SOAP), or some other protocol suitable for data transfer over a network 112. The shipment event processing application 115 may store the one or more instances of status events in shipment event data 130.

Next, the shipment event processing application 115 maps the instance or instances of status events obtained from the carrier to an instance of another status event that is normalized with respect to the status events that are used by all of the carriers. As a non-limiting example, the shipment event processing application 115 has a set of twenty different status events that are predetermined to represent normalized shipment statuses and to correspond to zero or more status events provided by the carriers. Thus, if a Carrier A has, for example, 10,000 status events, the 10,000 status events may map to some or all of the twenty normalized status events. Some of the status events of Carrier A may map to zero, one, or more than one of the normalized status events. In a specific application, a sequence of multiple different status events (e.g., a dozen or another number) may map to a single normalized status event. Likewise, the multiple different status events may map to a group of two or more normalized status events. In some cases, no status events of a particular carrier may map to a specific one or more of the normalized status events.

As another non-limiting example, different carriers may have different standards for what they consider to be damaged. In one embodiment, a damage status event from a carrier having a very low threshold for damage may not be mapped to a normalized status event or may be mapped to a normalized status event associated with no implemented action. Conversely, a damage status event from a carrier having a very high threshold for damage may be mapped to a normalized status event associated with an automated reshipping or refund.

The normalized status events may correspond to a diverse variety of status events that may be associated with shipments 148. The status events of such shipments 148 may include, but are not limited to, delivery attempted, available for pick up, tendered to local carrier for final delivery, incorrect address, customs clearance delay, delay due to external events, customer refused delivery, returning to seller due to refused delivery, delay due to the weather or a natural disaster, shipment 148 damaged and will not be delivered, shipment 148 lost, shipment 148 held for payment, delay due to extra carrier processing, confiscated by government authority, current location with Global Positioning System (GPS) coordinates, and/or other possible statuses.

The mapping of a carrier status event to a normalized status event may be performed using the carrier event maps 133. In one embodiment, the carrier event maps 133 may be implemented as a look-up table keyed on a string of identifiers 145 associated with the carrier status events. Given that the shipment event processing application 115 may map an aggregation of multiple carrier status events to one or more normalized status events, the shipment event processing application 115 may be configured to wait for additional carrier status events to be obtained before performing the mapping. The sequence in which the additional carrier status events are received may or may not define the particular normalized status event. In one embodiment, multiple carrier events received in a predefined chronological order are mapped to particular normalized status events.

In such cases, the shipment event processing application 115 may refer to the previous carrier status events that have been obtained for a shipment 148 in the shipment event data 130. As a non-limiting example, once the shipment event processing application 115 receives an instance of carrier event Y for a shipment 148, the shipment event processing application 115 consults the shipment event data 130 to determine whether an instance of carrier event X has been received for the shipment 148. If so, the shipment event processing application 115 may then map carrier event X and carrier event Y to normalized event Z. If not, the shipment event processing application 115 may map carrier event Y to normalized event W.

In response to the mapping of an instance of at least one normalized event, the shipment event processing application 115 implements one or more actions. The actions may be based at least in part on the instance of the normalized event, the order data 127 associated with the shipment 148, and/or other data. The actions may include sending a notification, annotating the order data 127 associated with the shipment 148, refunding the cost of the items in the shipment 148, refunding the shipping charges associated with the shipment 148, waiving shipping charges for other pending shipments 148 in the order or some other shipment 148, providing an offsetting concession such as a gift certificate, obtaining customer input, generating a map that displays a current location of the shipment 148, and/or other actions.

A notification may include a description of the status of the shipment 148 in words that are easily understandable to an ordinary user. The notification may be carrier generic or carrier specific. Sending a notification may involve, for example, sending an email message to an email address specified in order data 127. However, any method of communication may be used to effect a notification, including phone call, text message, and/or other communication methods. The form of communication may depend upon the type of normalized status event. As a non-limiting example, the customer may have to be called by phone for shipments 148 held for payment, delayed in customs, and/or associated with certain other statuses.

The notification may provide instructions regarding how to complete delivery of the shipment 148. As a non-limiting example, when a shipment 148 is available for pick-up at a location, the notification may instruct the customer where to pick up the package. As another non-limiting example, when a shipment 148 is held for payment by a carrier, the notification may instruct the customer what action is needed in order for the carrier to release the package (e.g., payment of a Collect on Delivery (COD) charge, payment of duty and taxes, etc.).

The notification may involve contacting the buyer who placed the order or a third party, such as an intended third-party gift recipient. The notification may include a description of the normalized status event, a description of the order and shipment 148, an automatic action, a suggested action, and/or other information. In one embodiment, sending a notification may be delayed and may relate to a plurality of normalized events and/or a plurality of orders or shipments 148. In such cases, the notification may represent an aggregation of normalized events and may be sent out regularly, for example, hourly, daily, weekly, or based on some other time period or trigger event.

In some embodiments, the notification may include a prompt for obtaining input data from the customer, or other user, in response to the notification. As a non-limiting example, the notification may display a link to a network page for the user to click on in order to register a selection among several choices. Also, the notification may provide a form or a link to a network page that provides a form within, for example, the browser 136. The notification may also receive user input by email, text message, phone call, and/or any other type of user input. The shipment event processing application 115 may be configured to store the user input from the customer, or other user, in the order data 127. In response to the user input, the shipment event processing application 115 may implement another action or actions based at least in part on the user input, the normalized event or events, the order data 127, and/or other data.

As a non-limiting example, a normalized status event may relate to an incorrect delivery address, and the customer may be notified that he or she provided what is considered to be an incorrect delivery address by the carrier. The customer client 106 may be sent a form in order for the customer to specify a corrected delivery address, and the shipment event processing application 115 may thereby obtain a corrected delivery address from the user in response to the notification. The corrected delivery address may then be forwarded by the shipment event processing application 115 to the carrier information system 139 and/or other systems of the carrier.

Refunds may also be implemented in response to certain normalized status events. Such refunds may be initiated automatically by the shipment event processing application 115. Alternatively, such refunds may be optional based on customer input. Depending on the particular normalized event or events, the refund may include the total cost of the order, the cost of one or more items shipped in the shipment 148, the shipping cost associated with the shipment 148, or some other amount. As a non-limiting example, a total refund may be implemented automatically in response to an event regarding an undeliverable shipment 148 that is damaged or confiscated by a government authority, while a refund of shipping costs may be implemented automatically for a shipment 148 delayed because of the carrier. In some embodiments, reshipping of the order, discounts, gift certificates, and/or other financial concessions may be implemented instead of refunds. In some embodiments, user input may be used in determining what type of financial concession to apply.

It is worth noting that the shipment event processing application 115 may take actions based on the contents of the shipment 148, which may be described in the order data 127. By contrast, the carrier information system 139 may not have access to all of the data contained within the order data 127. Furthermore, the shipment event processing application 115 may have the ability to reship lost or delayed items in an order automatically, refund an amount automatically to a payment method used by the customer to pay for the order, and/or perform other actions based on the data stored in order data 127.

Additionally, the pattern of normalized status events being processed by the shipment event processing application 115 may create a feedback loop enabling automated changes to shipment processes controlled by the order fulfillment application 121, ordering processes controlled by the electronic commerce application 118, and/or other processes. As a non-limiting example, if a carrier consistently produces damaged status events for deliveries in an area, the order fulfillment application 121 may be configured to select a different carrier automatically for future shipments 148 destined for that particular area. The shipment event processing application 115 may also keep track of the success rates associated with such process modifications, where the success rates are to be used in future process modifications.

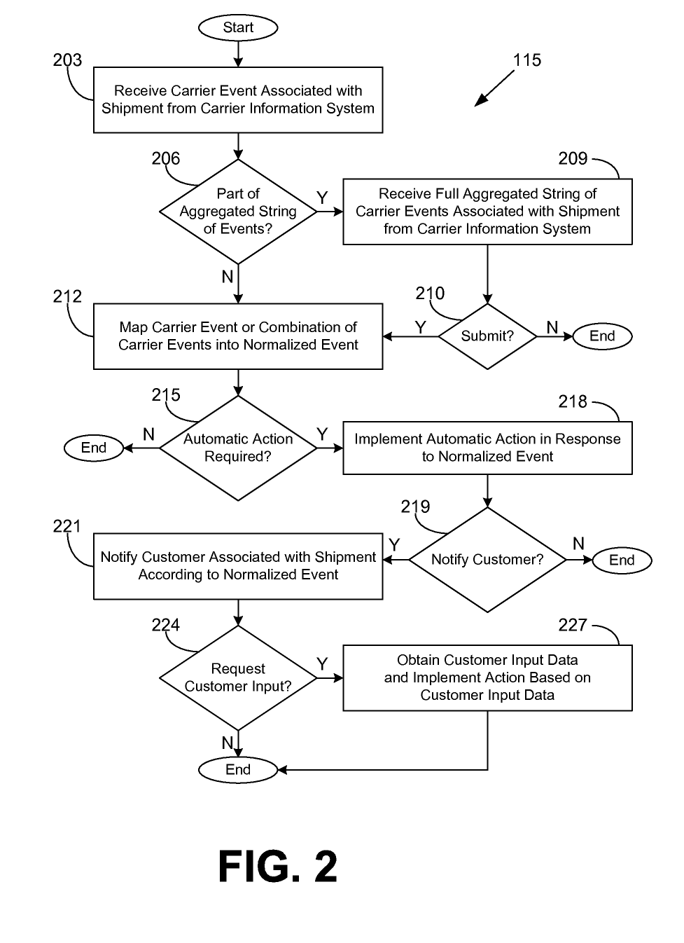

Moving now to FIG. 2, shown is a flowchart that provides one example of the operation of the shipment event processing application 115 (FIG. 1) according to various embodiments. It is understood that the flowchart of FIG. 2 provides merely an example of the many different types of functional arrangements that may be employed to implement the operation of the shipment event processing application 115 as described herein. As an alternative, the flowchart of FIG. 2 may be viewed as depicting an example of steps of a method implemented in the server 103 (FIG. 1) according to one or more embodiments.

Beginning with box 203, the shipment event processing application 115 receives a carrier event associated with a shipment 148 (FIG. 1) from a carrier information system 139 (FIG. 1). Specifically, the shipment event processing application 115 receives an instance of a carrier-specific status event with respect to the shipment 148. The shipment event processing application 115 may store the received carrier event in shipment event data 130 (FIG. 1). In box 206, the shipment event processing application 115 determines whether the carrier event is part of an aggregated string of events. That is, the shipment event processing application 115 determines whether it should wait for additional events, refer back to events previously received and stored in shipment event data 130, or neither.

If the shipment event processing application 115 determines that the received carrier event is part of an aggregated string of events, the shipment event processing application 115 moves to box 209 and receives a full aggregated string of carrier events associated with the shipment 148 from the carrier information system 139. In performing this task, the shipment event processing application 115 may need to wait to receive additional events and/or may need to retrieve past events from shipment event data 130. Events may be stored in shipment event data 130 when received to facilitate aggregation. Then, the shipment event processing application 115 moves to box 210 and determines whether a full aggregated string of carrier events has been submitted given the current event. If a full aggregated string of carrier events has not yet been submitted, the shipment event processing application 115 ends. Other events to be received later may complete the full aggregated string of carrier events. If a full aggregated string of carrier events has been submitted, the shipment event processing application 115 moves to box 212.

If, in box 206, the shipment event processing application 115 determines that the received carrier event is not part of an aggregated string of events, the shipment event processing application 115 also moves to box 212. In box 212, the shipment event processing application 115 maps the carrier event (or combination of carrier events, in the case of an aggregated string of carrier events received in a predefined chronological order) to a normalized event or events which have been predetermined to be potentially applicable to multiple carriers. In doing so, the shipment event processing application 115 refers to the carrier event maps 133 (FIG. 1) to perform the mapping.

Next, in box 215, the shipment event processing application 115 determines whether automatic action is needed in response to the normalized event. Such a determination may be based, for example, on the type of normalized event, the carrier that originated the event, etc. If the shipment event processing application 115 determines that automatic action is needed, the shipment event processing application 115 proceeds to box 218 and implements one or more automatic actions in response to the normalized event. The automatic action may also be in response to order data 127 (FIG. 1) for the shipment 148 and other data. The automatic action may include, for example, making a refund, reshipping an order, etc. Then, the shipment event processing application 115 moves to box 219. If, in box 215, the shipment event processing application 115 determines that automatic action is not needed, the shipment event processing application 115 ends in this embodiment.

In box 219, the shipment event processing application 115 determines whether customer notification is needed. If customer notification is not needed, the shipment event processing application 115 ends. If the customer or another third party is to be notified, then in box 221, the shipment event processing application 115 notifies the customer or other third party associated with the shipment 148 according to the status of the shipment 148 based on the normalized event. The notification may also be based on order data 127 associated with the shipment 148. The notification may be performed by email, text message, phone call, network page, and/or other methods of communication. The notification may involve storing status data that will be accessed later by a user via, for example, a network page. In some embodiments, the notification may be made to a third party, such as an intended gift recipient or some other party.

The shipment event processing application 115 then proceeds to box 224 and determines whether to request customer input. If customer input is not to be requested, the shipment event processing application 115 ends. If customer input is to be requested, in box 227, the shipment event processing application 115 obtains customer input data and implements an action based on customer input data and possibly other data. It is understood that such an action may additionally be based on other data. Also, the input may be requested of a third party, such as an intended gift recipient or some other party. The shipment event processing application 115 then ends.

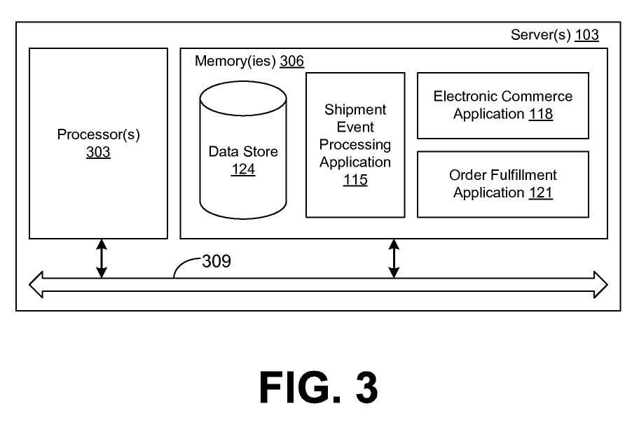

Referring next to FIG. 3, shown is a schematic block diagram of the server 103 (FIG. 1) according to an embodiment of the present disclosure. The server 103 includes a processor circuit, for example, having a processor 303 and a memory 306, both of which are coupled to a local interface 309. To this end, the server 103 may comprise, for example, a server computer or like device. The local interface 309 may comprise, for example, a data bus with an accompanying address/control bus or other bus structure as can be appreciated.

Stored in the memory 306 are both data and several components that are executable by the processor 303. In particular, stored in the memory 306 and executable by the processor 303 are a shipment event processing application 115 (FIG. 1), electronic commerce application 118 (FIG. 1), order fulfillment application 121 (FIG. 1), and potentially other applications. Also stored in the memory 306 may be a data store 124 (FIG. 1) and other data. In addition, a server operating system may be stored in the memory 306 and executable by the processor 303.

It is understood that there may be other applications that are stored in the memory 306 and are executable by the processors 303 as can be appreciated. Where any component discussed herein is implemented in the form of software, any one of a number of programming languages may be employed such as, for example, C, C++, Java, Java Script, Perl, Python, Flash, or other programming languages.

A number of software components are stored in the memory 306 and are executable by the processor 303. In this respect, the term “executable” means a program file that is in a form that can ultimately be run by the processor 303. Examples of executable programs may be, for example, a compiled program that can be translated into machine code in a format that can be loaded into a random access portion of the memory 306 and run by the processor 303, source code that may be expressed in proper format such as object code that is capable of being loaded into a random access portion of the memory 306 and executed by the processor 303, or source code that may be interpreted by another executable program to generate instructions in a random access portion of the memory 306 to be executed by the processor 303, etc. An executable program may be stored in any portion or component of the memory 306 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 306 is defined herein as including both volatile and nonvolatile memory and data storage components. Volatile components are those that do not retain data values upon loss of power. Nonvolatile components are those that retain data upon a loss of power. Thus, the memory 306 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 303 may represent multiple processors and the memory 306 may represent multiple memories that operate in parallel processing circuits, respectively. In such a case, the local interface 309 may be an appropriate network that facilitates communication between any two of the multiple processors 303, between any processor 303 and any of the memories 306, or between any two of the memories 306, etc. The local interface 309 may comprise additional systems designed to coordinate this communication, including, for example, performing load balancing. The processor 303 may be of electrical or of some other available construction.

Although the shipment event processing application 115, electronic commerce application 118, order fulfillment application 121, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowchart of FIG. 2 shows the functionality and operation of an implementation of portions of the shipment event processing application 115. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flowchart of FIG. 2 shows a specific order of execution, it is understood that the order of execution may differ from that which is depicted. For example, the order of execution of two or more blocks may be scrambled relative to the order shown. Also, two or more blocks shown in succession in FIG. 2 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the shipment event processing application 115, electronic commerce application 118, and order fulfillment application 121, that comprises software or code can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A method, comprising the steps of:
obtaining, in at least one server, an instance of at least one first event from a first one of a plurality of carriers, the instance of the at least one first event being associated with a shipment in transit with the first one of the carriers, the at least one first event being associated with a first one of a plurality of sets of first events used by at least one of the carriers to describe shipment status, the first one of the sets of first events being associated with the one of the carriers;
mapping, in the at least one server, the instance of the at least one first event to an instance of a second event, the second event being associated with a set of second events, each of the second events describing a shipment status and being normalized with respect to the sets of first events associated with the carriers;
obtaining, in the at least one server, an instance of a subsequent first event from a second one of the carriers, the instance of the subsequent first event being associated with a shipment in transit with the second one of the carriers, the subsequent first event differing from the at least one first event and being associated with a second one of the sets of first events;
mapping, in the at least one server, the instance of the subsequent first event to a subsequent instance of the second event; and implementing, in the at least one server, at least one action based at least in part on the subsequent instance of the second event and order data associated with the shipment in transit with the second one of the carriers.

2. A method, comprising the steps of:
obtaining, in at least one server, an instance of at least one first event from one of a plurality of carriers, the instance of the at least one first event being associated with a shipment in transit with the one of the carriers, the at least one first event being associated with one of a plurality of sets of first events used by at least one of the carriers to describe shipment status, the one of the sets of first events being associated with the one of the carriers;
mapping, in the at least one server, the instance of the at least one first event to an instance of a second event, the second event being associated with a set of second events, each of the second events describing a shipment status and being normalized with respect to the sets of first events associated with the carriers; and
implementing, in the at least one server, at least one action based at least in part on the instance of the second event.

3. The method of claim 2, wherein the at least one first event comprises at least two first events.

4. The method of claim 3, wherein the at least two first events are obtained in a predefined chronological order.

5. The method of claim 2, wherein the at least one action is based at least in part on order data associated with the shipment.

6. The method of claim 2, wherein the one of the sets of first events comprises a first one of the sets of first events, and the method further comprising the steps of:
obtaining, in the at least one server, an instance of a subsequent first event from a second one of the carriers, the instance of the subsequent first event being associated with a shipment in transit with the second one of the carriers, the subsequent first event differing from the at least one first event and being associated with a second one of the sets of first events;
mapping, in the at least one server, the instance of the subsequent first event to a subsequent instance of the second event; and
implementing, in the at least one server, another at least one action based at least in part on the subsequent instance of the second event.

7. The method of claim 6, wherein the at least one action is based at least in part on order data associated with the shipment in transit with the second one of the carriers.

8. The method of claim 5, wherein the at least one action is based at least in part on contents of the shipment.

9. The method of claim 2, wherein the at least one action comprises the step of generating a map that displays a current location of the shipment.

10. The method of claim 5, wherein the at least one action comprises the step of automatically providing a concession to a customer.

11. The method of claim 10, wherein the concession comprises at least one of the following: a refund, a refund of a shipping charge associated with the shipment, a waiver of a shipping charge associated with other pending shipments, a gift certificate, or a reshipment of at least one item.

12. The method of claim 5, wherein the at least one action comprises the step of sending a notification to a customer.

13. The method of claim 12, wherein the at least one action further comprises the steps of:
obtaining input data from the customer in response to the notification; and
implementing another at least one action based at least in part on the input data.

14. The method of claim 12, wherein the notification describes a plurality of second events.

15. The method of claim 12, wherein the notification provides instructions regarding how to complete delivery of the shipment.

16. The method of claim 5, wherein the second event relates to an incorrect delivery address and the at least one action comprises the step of obtaining a corrected delivery address from a customer.

17. The method of claim 2, wherein the at least one action comprises the step of adjusting an expected delivery time.

18. The method of claim 2, wherein the second event relates to damage of the shipment.

19. The method of claim 2, wherein the second event relates to loss of the shipment.

20. The method of claim 2, wherein the second event relates to delay of the shipment.

21. The method of claim 5, wherein the order data comprises items contained within the shipment and a cost of the items.

22. A system, comprising:
at least one server; and
a shipment event processing application executable in the at least one server, the shipment event processing application comprising:
logic that obtains an instance of at least one first event from one of a plurality of carriers, the instance of the at least one first event being associated with a shipment in transit with the one of the carriers, the at least one first event being associated with one of a plurality of sets of first events used by at least one of the carriers to describe shipment status, the one of the sets of first events being associated with the one of the carriers;
logic that maps the instance of the at least one first event to an instance of a second event, the second event being associated with a set of second events, each of the second events describing a shipment status and being normalized with respect to the sets of first events associated with the carriers; and
logic that implements at least one action based at least in part on the instance of the second event.

23. The system of claim 22, wherein the at least one action is based at least in part on order data associated with the shipment.

24. The system of claim 22, wherein the one of the sets of first events comprises a first one of the sets of first events, and the shipment event processing application further comprises:
logic that obtains an instance of a subsequent first event from a second one of the carriers, the instance of the subsequent first event being associated with a shipment in transit with the second one of the carriers, the subsequent first event differing from the at least one first event and being associated with a second one of the sets of first events;
logic that maps the instance of the subsequent first event to a subsequent instance of the second event; and
logic that implements another at least one action based at least in part on the subsequent instance of the second event.

25. The system of claim 23, wherein the at least one action comprises:
logic that sends a notification to a customer;
logic that obtains input data from the customer in response to the notification; and
logic that implements another at least one action based at least in part on the input data.

26. The system of claim 23, wherein the at least one action is based at least in part on contents of the shipment.

27. The system of claim 23, wherein the at least one action comprises logic that automatically provides a concession to a customer.

28. The system of claim 23, wherein the order data comprises items contained within the shipment and a cost of the items.
